(19) United States
(12) Patent Application Publication
(10) Pub. No.: US 2017/0349486 A1
(43) Pub. Date: Dec. 7, 2017

(54) METHOD FOR PRODUCING SINTERED MATERIAL FROM AN INORGANIC RAW MATERIALS

(71) Applicant: FIVES FCB, Villeneuve D'ascq (FR)

(72) Inventor: Alain CORDONNIER, Villeneuve D'ascq (FR)

(73) Assignee: FIVES FCB, Villeneuve D'ascq (FR)

(21) Appl. No.: 15/540,932

(22) PCT Filed: Jan. 7, 2016
(86) PCT No.: PCT/FR2016/050024

§ 371 Date: Jun. 29, 2017

(30) Foreign Application Priority Data
Jan. 12, 2015 (FR) 15 50200

(51) Int. Cl. C04B 7/47; F27D 15/02; F27B 7/38; F27B 7/14; F27B 7/34; F27B 7/20; F27D 17/00; F27B 7/42

(52) U.S. Cl. CPC C04B 7/475; F27D 17/004; F27D 15/0213; F27B 7/42; F27B 7/14; F27B 7/34; F27B 7/2033; F27B 7/383

(57) ABSTRACT

Disclosed is a method for producing sintered material from organic raw materials, implemented in an apparatus comprising, a cyclone preheater, a rotary furnace and a grate cooler, and in which the raw materials are preheated in the cyclone preheater, the preheated material is calcined and sintered in the rotary furnace, and the calcined materials are cooled by blowing cooling air in the grate cooler, producing hot air. The hot air is separated into three upstream-to-downstream fractions, the three hot air fractions being at decreasing temperatures. The first air fraction acts as combustion air in at least the combustion zone of the rotary furnace and/or of the potential precalciner of the apparatus. The second air fraction is greater than the combustion air needs to produce energy. The third air fraction is directed at least in part to the combustion zone of the apparatus, providing combustion air with the first air fraction.

The invention relates to a method for producing sintered material from mineral raw materials, implemented in an installation comprising a cyclone preheater, a rotary furnace and a grate cooler. The field of the invention is that of methods and installations for the manufacture of cement clinker.

The manufacture of cement clinker most often uses a so-called dry process burning method, wherein the raw materials crushed beforehand, are calcined then sintered in a rotary furnace. In order to decrease the energy needs of the operation, exchangers were added upstream and downstream of the rotary furnace, respectively called clinker preheater and cooler, and respectively recover upstream in the material the heat contained in the fumes exiting the furnace and downstream in the gases the heat contained in the sintered materials. As such, while the products exiting the furnace have a temperature greater than 1000° C., the flows of hot gases, air or fumes, that exit from these exchangers without being used for the burning operation are now only at temperatures generally less than 350° C. However, they still contain a quantity of heat that can represent 20 to 30% of the energy introduced in the form of fuel in the burning installation.

The hot gases coming from the preheater are generally used outside of the burning operation for the drying of the raw materials which are used for the manufacture of the clinker. But only a portion is necessary except in cases where the humidity of the materials is very high. The hot air coming from the clinker cooler is partially used as combustion air in the installation; most often this represents only about half of the volume of hot air produced. There remains therefore in general flows of hot gases that form a source of available energy. In particular, the flow of hot air coming from the clinker cooler is most often not used.

The recovery of the lost heat for the purposes of producing electricity is known and practiced in many factories. The most common method consists in directing the hot gases to exchangers comprised of tubes wherein water circulates that the heat transforms into steam, which moves the turbine of an electricity generator. There can be one exchanger per flow of gas, or the flows can be joined together before treating them in a single exchanger. In light of the moderate temperature of the gases, the global output of the conversion of the energy into electricity is low, and fluids other than water are sometimes used, such as pentane for example, with the purpose of improving performance. Despite this, the output remains less than 20% which is clearly less than the output of a conventional thermal power plant for producing electricity.

In the case of the clinker cooler, the operating principle of the grate cooler leads to producing flows of air at decreasing temperatures, from upstream to downstream according to the direction of displacement of the material in the cooler. As such, the hot air that is first recovered, in one or several flows, usually referred to as secondary air and tertiary air, is at temperatures ranging typically from 750° C. to 1200° C. and is used as combustion air in the installation typically at the level of the burners of the rotary furnace and/or of the precalcinator of the installation, while the average temperature of the unused air, which is greater than the combustion air needs, is less than about 250° C. This temperature level is not favourable for good conversion output.

In order to increase the conversion output, it is commonly known and practiced to separate the unused air into two flows, an intermediate flow of which the temperature is higher, greater than 300° C., and an exhaust gas that is abandoned. This is described for example in document [Tatsuo Ino—Waste heat recovery power generation in cement plants—VdZ seminar, Dusseldorf, September 2009].

This requires a compromise between the quantity of heat available that is abandoned and the gain in the temperature of the valorised air which allows for an improvement in the conversion output. The abandoning of a portion of the available heat is a notable disadvantage of the method.

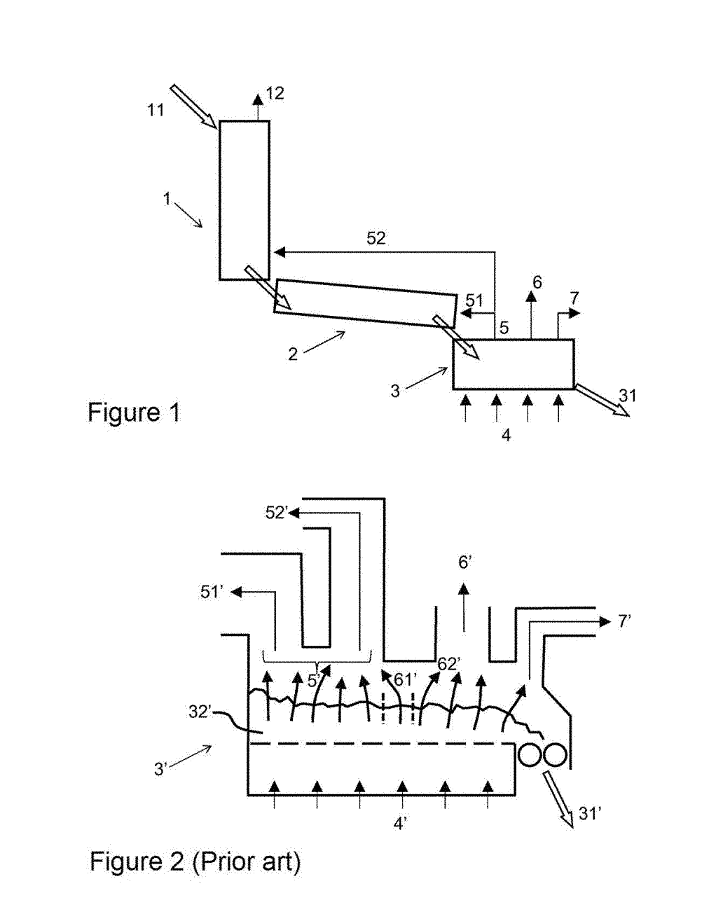

Such prior art is shown in FIG. 1 of document WO 2009/156614A1 with an installation for manufacturing cement clinker that comprises a cyclone preheater, a rotary furnace and a clinker cooler. In such an installation, the raw materials are preheated in the cyclone preheater, they are precalcined in a precalcinator associated with the cyclone preheater, the preheated materials are calcined in the rotary furnace, and the calcined materials are cooled in the cooler. The clinker exiting the furnace is cooled in the cooler by blowing air on the hot clinker. The hot air produced by the cooler is divided into several flows, namely so-called secondary air used in the furnace as combustion air, so-called tertiary air used as combustion air in the precalcinator, and air that is greater than the combustion air needs of the installation. According to FIG. 8, only the hottest portion of this flow of excess air is used in an exchanger, marked as 9, for the purpose of producing electricity, with another portion of the air, at lower temperature, being conducted separately, downstream, and abandoned.

The purpose of this invention is to overcome the aforementioned disadvantages by proposing a method for producing sintered material from mineral raw materials, implemented in an installation comprising a cyclone preheater, a rotary furnace, and a grate cooler by blowing air, that uses a portion of the hot air as combustion air in the installation, and another portion, which is greater than the combustion air needs, for the production of energy, in particular electricity, and advantageously output that is superior in relation to the prior art described hereinabove.

Another purpose of this invention is to propose, at least according to an embodiment of the invention, a method that makes it possible to only discharge into the atmosphere gases of a moderate temperature, in particular less than 65° C., for example less than or equal to the ambient temperature.

Other purposes and advantages shall appear in the following description which is provided solely for the purposes of information and which does not have for purpose to limit it.

Also the invention relates to a method for producing sintered material from mineral raw materials, implemented in an installation comprising:
a cyclone preheater,
a rotary furnace,
a grate cooler,

method wherein the raw materials are preheated in the cyclone preheater, they are possibly precalcined in a precalcinator associated with the cyclone preheater, the preheated materials are calcined and sintered in the rotary furnace, and the calcined materials are cooled by blowing cooling air in the grate cooler,

and wherein the hot air generated by the grate cooler is separated into three fractions, said three hot air fractions being at the decreasing temperatures, comprising respectively, from upstream to downstream, according to the direction of advancement of the materials in the grate cooler, a first air fraction acting as combustion air in at least said combustion zone of the rotary furnace and/or of the possible precalciner of the installation, a second intermediate air fraction, and a third air fraction, at lower temperature.

According to the invention, at least one portion of the air of the third fraction is directed to said at least one combustion zone of the rotary furnace and/or of the precalcinator to be used as combustion air with said first air fraction, and said second air fraction, greater than the combustion air needs, is valorised for the production of energy, in particular electricity.

As such, the invention consists in increasing the temperature and the enthalpy of the second intermediate air fraction, by using as combustion air, not only, and conventionally, the first air fraction, of a higher temperature, but also, and according to the invention, at least one portion of the air of the third fraction, at lower temperature, which according to the prior art described hereinabove, is only a an excess exhaust flow.

As the needs for combustion air of the installation are defined, the flow rate of the portion of the air of the third fraction, at lower temperature, used as combustion air decreases by as much the flow rate of air required of the first air fraction in order cover the combustion air needs, and by comparison with the prior art described hereinabove. This flow rate of very hot air replaced as such makes it possible to advantageously feed the second intermediate air fraction, and as such to increase the temperature thereof and its enthalpy. Such a principle shall be described and shown in more detail in the rest of the description.

The invention makes it possible as such to use the air of the second fraction in an exchanger, such as a water/steam boiler, associated with a turbine, or any other device that allows for a conversion into electrical energy.

According to an embodiment, the flow rate of said portion of the air of said third fraction is adjusted so that the temperature of said second intermediate air fraction, is maintained constant at a predetermined value (for example 450° C.), despite the fluctuations in the method in particular linked to the instantaneous variations in the flow rate, granulometry and temperature of the clinker at the inlet of the cooler. To this effect, the flow rate of said portion of the air of the third fraction used as combustion air is increased in order to increase the temperature of the second fraction or offset its downward trend. The flow rate of the portion of the air of the third fraction used as combustion air is decreased in order to provoke the opposite effect, namely the decrease in the temperature of the second air fraction.

According to an embodiment, said installation comprises said precalcinator associated to the cyclone preheater and wherein the first air fraction comprises the secondary air used as combustion air at the rotary furnace and of the tertiary air, conveyed separately to said precalcinator.

According to an embodiment, said portion of the air of said third fraction used as combustion air is mixed with the tertiary air, without being mixed with the secondary air.

According to an embodiment, the air cooled by said exchanger is used as cooling air at said grate cooler. Such an arrangement makes it possible to suppress any exhaust flow of the cooler, in particular in the case where the third air fraction is used entirely as combustion air. According to another alternative for which only a portion of the air of the third fraction is used as combustion air, mixed with the combustion air of the first fraction, with another remaining portion being conveyed separately from said portion, it is still possible to suppress any exhaust flow to the cooler by using this remaining portion of the third fraction as cooling air at said grate cooler.

According to an embodiment, the fumes coming from the cyclone preheater are directed to an exchanger for the purpose of concerting the heat into electricity.

According to an embodiment, the exchangers respectively treating the second air fraction and the fumes of the cyclone preheater cooperate for the production of electricity. For example, one of the exchangers can be that of a steam generator, the other that of a steam superheater.

The method has a particular application in the manufacture of cement clinker.

The invention shall be better understood when reading the following description accompanied with annexed drawings among which:

FIG. 1 diagrammatically shows a burning and sintering installation of materials such as cement materials,

FIG. 2 is a detailed view showing the various flows of hot air generated by the grate cooler of the installation of FIG. 1 and such as known in prior art,

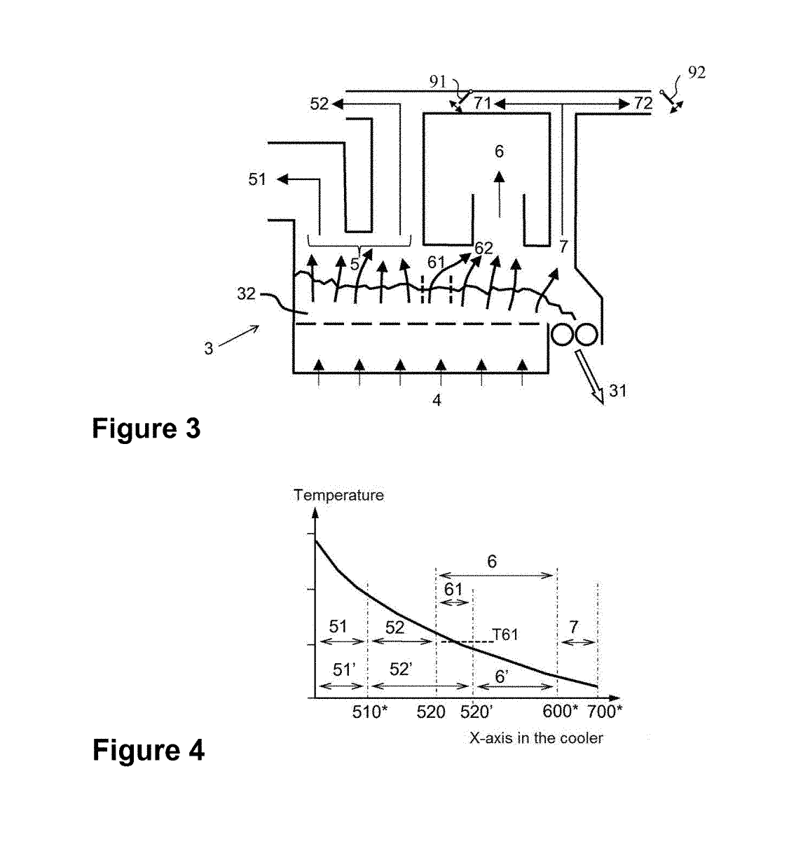

FIG. 3 is a detailed view showing the various flows of hot air generated by the grate cooler of the installation of FIG. 1 and in accordance with the invention,

FIG. 4 is a graph showing, on the y-axis, the local temperature of the flow of hot air, and according to its position in the cooler,

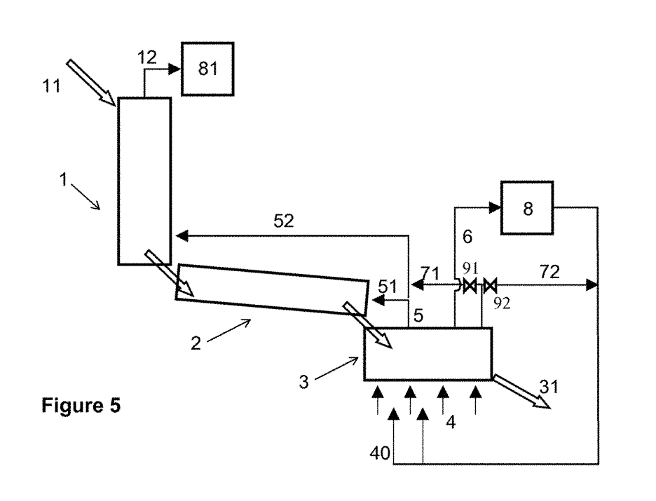

FIG. 5 diagrammatically shows a burning and sintering installation of materials such as cement materials, in accordance with the invention according to an embodiment.

We shall first of all begin by describing an installation wherein the raw mineral materials 11 are subjected to a treatment, successively of preheating in a cyclone preheater 1, possible precalcination in a precalciner associated with the preheater, then of calcination and sintering in a rotary furnace 2. The hot materials 32 exiting the rotary furnace 2 are cooled in a grate cooler 3, from which they exit in the form of cooled sintered materials 31. The cooling of the hot materials 32 takes place via the blowing of air 4 under the grate of the cooler 3, which in contact with the hot materials generates hot air of which the local temperature decreases from upstream to downstream, according to the direction of displacement of the materials in the cooler.

It is known to extract various flows of hot air from the cooler, of decreasing temperatures, from upstream to downstream in the cooler, respectively a first air fraction 5′ intended to cover the combustion air needs of the installation, a second intermediate air fraction 6′, and a third air fraction 7′.

The first air fraction can as such include a so-called secondary air 51′, channelled to the burner or burners of the rotary furnace 2′ where it is used as a combustion agent for a fuel, and a tertiary air 52′, at lower temperature, channelled separately to the burner or burners of the precalcinator (not shown) where it is used as a combustion agent for a fuel.

FIG. 2 shows a grate cooler 3′ under which air 4′ is blown which by passing through the bed of hot materials 32′ gives rise to many streams of hot air which are grouped together as secondary air 51′, tertiary air 52′, as a second intermediate air fraction 6, and as a third air fraction 7, of exhaust, of which the distribution depends on the suction exerted at each one of the exists. An example is shown of a stream of air 61′ that is directed to the tertiary air 52′ while the adjacent stream 62′ is directed to the second intermediate air fraction 6′.

Such as shown in FIG. 2, and according to the prior art known to the applicant, the secondary air 51′ and the tertiary air 52′ cover the combustion air needs of the burners of the rotary furnace 2 and of the precalcinator. The second air fraction 6′ and the third fraction 7′ represent a flow rate of air that is greater than the combustion needs of the installation. According to this prior art, it is known to valorise this excess air in one or several exchangers for the purpose of producing electricity. In order to increase the conversion output, it is common to use in the exchangers only the second intermediate air fraction 6′, typically of a temperature greater than or equal to 300° C., and to discharge into the atmosphere the third air fraction 7′, of a temperature that is too low, and without valorisation of the contained heat.

FIG. 3 shows an alternative of the method according to the invention. The hot materials 32 exiting the furnace are cooled in the grate cooler by blowing of air 4. The air in contact with the materials is heated, generating hot air which is divided into three flows, from upstream to downstream, according to the direction of advancement of the materials in the cooler 3, namely respectively, a first air fraction 5, a second intermediate air fraction 6, and a third air fraction 7.

The first air fraction 5, which is the hottest, is used as combustion air in the installation in particular in the burner or burners of the rotary furnace 3 and/or of the precalcinator. The first air fraction 5 can be divided into a secondary air 51 used as combustion air in the burner or burners of the rotary furnace, and into a tertiary air 52 used as combustion air in the burner or burners of the precalcinator. On the other hand, and contrary to the prior art of FIG. 2, the first air fraction 5 does not alone cover the combustion air needs of the installation. To this effect, and according to the invention, it is necessary to add to it all or a portion of the air of the third air fraction 7. As such and according to the embodiment of FIG. 3, the combustion air needs of the installation are satisfied by the first air fraction 5, and a portion 71 of the third air fraction 7.

As the combustion air needs of the installation are defined, the flow rate of the portion 71 of the air of the third fraction 7, at lower temperature, used as combustion air decreases by as much the flow rate of the air required of the first air fraction 5 in order to cover the combustion air needs, and by comparison to prior art described hereinabove and shown in FIG. 2. This flow rate of very hot air replaced as such then makes it advantageously possible to feed the second intermediate air fraction 6, and as such to increase the temperature thereof and its enthalpy. This is shown in detail in FIG. 3: it is as such observed that the stream of air 61 is turned away from the tertiary air 52 towards which it was directed in conventional operation, shown in FIG. 2, (see stream 61′ shown in FIG. 2 according to prior art). This stream of air 61 now feeds the second intermediate air fraction 6. According to this embodiment, only a portion 71 of the third air fraction is directed to the first air fraction 5, in particular the tertiary air 52, with the other portion being evacuated.

The flow rate of said portion of air 71 of the third air fraction 7 can be adjusted to vary the flow rate of the stream of air 61 and as such offset the fluctuations of the enthalpy of the second air fraction 6 which are the result of the instantaneous variations in the flow rate, granulometry or temperature of the clinker at the inlet of the cooler 3.

As such, the temperature of the second air fraction 6 can be maintained constant at a predetermined value by an adjustment of the flow rate of said portion 71 of the third air fraction 7 used as combustion air. This adjustment in the flow rate can be obtained thanks to the adjusting of the position of at least one adjusting member 91, 92, such as a flap located on at least one of the ducts that convey the portions 71 and 72 of the third air fraction. For example, a first adjusting member 91, such as a flap, can be provided on the duct conveying the portion 71 of the air used as combustion air, and a second adjusting member 92 can be provided on the duct of the other portion of air 72. During the adjusting, the flow rate of said portion 71 of the air of the third air fraction 7 used as combustion air is increased in order to increase the temperature of the second air fraction 6 or offset its downward trend, in particular when the temperature of the second fraction is less than the predetermined value. The flow rate if the portion 71 of the air of the third air fraction 7 used as combustion air is decreased in order to provoke the opposite effect, namely the decrease of the temperature of the second fraction 6, in particular when the temperature of the second air fraction is greater than the predetermined value. The predetermined value, adjustment setpoint, can be chosen between 300° C. and 500° C., and in particular between 350° C. and 480° C. This adjustment can be implemented by an automatic device, that comprises at least as input the signal of a temperature sensor targeting the temperature of the second air fraction 6, and for output(s) at least one control signal of at least one actuator of said at least one adjusting member 91, 92.

The graph of FIG. 4 shows the change in the temperature of the material in the cooler according to the position on the grid of the cooler between the inlet and the outlet. Towards the inlet, the temperature can be close to 1450° C. while at the outlet the temperature can be close to 100° C. The X coordinates 510*, 520′, 600*, 700* with which the streams of air are separated are defined in order to give rise to the flows 51′, 52′, 6′ and 7′ according to the prior art of FIG. 2, and the X coordinates 510*, 520, 600*, 700* with which the streams of air are separated in order to give rise to the flows 51, 52, 6 and 7 according to the embodiment of the invention of FIG. 3. The flow of the stream 61 is distinguished which joins the second intermediate air fraction 6, according to the invention. Its average temperature is greater than the temperature of all of the portions of the flow of the second air fraction 6′ according to the prior art of FIG. 2. In the end the average temperature and the enthalpy of the second intermediate fraction 6 according to the method of the invention are greater than the temperature and the enthalpy of the second intermediate fraction 6′ according to the prior art shown in FIG. 2.

The installation of FIG. 5, in accordance with the invention according to an embodiment, comprises a cyclone preheater 1, a rotary furnace 2, and a grate cooler 3. The raw mineral materials 11 are preheated in the cyclone preheater 1, they are precalcined in a possible precalcinator at the base of the preheater 1, before calcinating them and sintering them in the rotary furnace 2. The hot materials 32 are cooled in the grate cooler 3, where they exit in the form of cooled sintered materials. Air 4 is blown under the grate of the cooler, which in contact with the hot materials is heated and produces hot air of which the temperature decreases from upstream to downstream of the cooler 3. The hot air is separated into three fractions, from upstream to downstream, according to the direction of advancement of the materials in the grate cooler, with said three fractions of hot air being at decreasing temperatures, comprising respectively a first air fraction 5 acting as combustion air in at least said combustion zone (of the rotary furnace and/or of the potential precalciner of the installation), a second intermediate air fraction 6, and a third air fraction 7, at lower temperature.

The first air fraction 5 can comprise secondary air 51, intended to serve as combustion air at the rotary furnace 2 and as tertiary air 52 intended to serve as combustion air at the precalcinator. A portion 71 of the third air fraction 7 is mixed with the tertiary air 52, in order to serve as combustion air at the precalcinator. According to this embodiment, the other portion 72 of the third fraction 7, as well as the second air fraction 6 are greater than the combustion air needs of the installation.

The second air fraction 6, of an average temperature greater than the air of the portion 72, is conveyed to an exchanger 8 for the purpose of converting the heat into electrical energy. This exchanger 8 can be that of a water/steam boiler, intended to cooperate with a turbine coupled to an alternator, or any other device known to those skilled in the art that can transform heat into electrical energy. After thermal transfer, the air cooled by the exchanger 8 can be directed to the grate cooler 3 in order to serve as cooling air 40. The other portion 72 of the third fraction, greater than the combustion air needs, can be directed to the cooler 3 in order to also serve as cooling air 40 and without cooperating with the exchanger 8. According to this embodiment, the cooler 3 does not provoke any discharge of hot air into the atmosphere.

According to an embodiment, the fumes of the rotary furnace feed the various cyclones of the preheater 1, and were partially cooled in the preheater by contact and the thermal exchanges with the raw mineral materials 11. According to an embodiment, the fumes 12 coming from the cyclone preheater 1 are directed to an exchanger 81 for the purpose of converting heat into electricity. The exchangers 8 and 81 respectively treating the second air fraction 6 and the fumes 12 of the cyclone preheater can possibly cooperate for the production of electricity. One of the exchangers, for example the exchanger 81 can be part of a steam generator, the other exchanger, for example the exchanger 8, can be part of a steam superheater, or inversely according to the temperatures of these flows.

### EXAMPLE 1

Consider a cement factory burning installation that consumes 2955 kJ in combustible energy per kg of clinker produced, with a cooler that receives 1.837 Nm³ of air per kg of clinker to be cooled. 0.909 Nm³ of combustion air is produced, respectively 0.335 Nm³ of secondary air at 1160° C. and 0.574 Nm³ of tertiary air at 830° C. The unused air has a volume of 0.928 Nm³ and a temperature of 223° C.

With the purpose of recovering the unused heat and converting it into electrical energy by using a water/steam boiler, the unused air is separated into two flows, an intermediate flow of 0.664 Nm³ at 260° C. of which the increased temperature makes it possible to obtain better conversion output, and an exhaust flow of 0.264 Nm³ at 130° C., which is abandoned. As such, for an installation that produces 3000 t/d of clinker, 0.77 MW can be produced which corresponds to an output of 17.1%.

According to the invention, the exhaust flow (i.e. the third air fraction) is directed to the tertiary air, and the tertiary air replaced is mixed with the intermediate flow (i.e. the second air fraction). The lowering of the temperature of the combustion air provokes an increase in the thermal consumption which reaches 3285 kJ per kg of clinker. Taking into account the corresponding increase in the combustion air needs, there is then an intermediate flow of 0.878 Nm³ at 411° C. For the installation of 3000 t/d already mentioned, it is possible to produce 2.73 MW, which corresponds to an output of 22.4% and energy multiplied by 3.5. The marginal output of the combustible energy added is 18.5% which is economically interesting in a cement factory that consumes alternative fuels at low cost.

### EXAMPLE 2

For the same installation as that described in example 1, electrical energy is produced by using an Organic Rankine Cycle. The unused air is separated into two flux, an intermediate flow of 0.729 Nm³ at 250° C. and an exhaust flow of 0.199 Nm³ at 123° C. that is abandoned. As such, for an installation that produces 3000 t/d of clinker, it is possible to produce 0.52 MW which corresponds to an output of 15.2%.

According to an embodiment of the invention, a portion of the exhaust flow (i.e. the third air fraction) is directed to the tertiary air, and the tertiary air replaced is mixed with the intermediate flow (i.e. the second air fraction): 0.115 Nm³ are as such redirected while again 0.084 Nm³ is abandoned. The drop in the temperature of the combustion air provokes an increase in the thermal consumption which reaches 3104 kJ per kg of clinker. By taking into account the corresponding increase in the combustion air needs, there is then an intermediate flow of 0.818 Nm³ at 350° C. For the installation of 3000 t/d already mentioned, it is possible to produce 1.46 MW, which corresponds to an output of 19.6% and energy multiplied by 2.8. The marginal output of the combustible energy added is 23.5% which is economically interesting in a cement factory that consumes alternative fuels at a low price.

The invention applies to any burning installation of mineral materials that produces a sintered material that is cooled by blowing air in a grate cooler and of which the hot air produced as such is partially used as combustion air in the burning installation.

Naturally other embodiments of the invention could have been considered by those skilled in the art without however leaving the scope of the invention such as defined by the claims hereinafter.

### NOMENCLATURE

Invention:
1. Cyclone preheater,
2. Rotary furnace,
3. Grate cooler,
4. Cooling air,
5. First air fraction (Hot air),
6. Second air fraction (Hot air),
7. Third air fraction (Hot air),
8, 81. Exchangers,
11. Raw mineral materials,
12. Fumes from the preheater,
31. Cooled sintered materials,
32. Hot materials,
40. Cooling air
51. Secondary air,
52. Tertiary air,
61, 62. Streams of air (Second air fraction 6),
71. Portion of the air of the third air fraction 7 used as combustion air,
72. Portion of the third air fraction 7 used as cooling air,
91. Flow rate adjusting member (on the duct conveying the portion of air 71),
92. Flow rate adjusting member (on the duct conveying the portion of air 72),
Prior art (FIG. 2):
3′. Grate cooler,
4′. Cooling air,
5′. First air fraction
6′. Second air fraction,
7′. Third air fraction,
31′. Cooled sintered materials,
32′. Hot materials,
51′. Secondary air,
52′. Tertiary air,
61′, 62′. Streams of air (respectively of the tertiary air 52′ and of the second air fraction 6′),

1. Method for producing sintered material from mineral raw materials (11), implemented in an installation comprising:
a cyclone preheater (1),
a rotary furnace (2),
a grate cooler (3),
method wherein the raw materials (11) are preheated in the cyclone preheater (1), they are possible precalcined in a precalcinator associated with a cyclone preheater, the preheated materials are calcined and sintered in the rotary furnace (2), and the calcined materials are cooled by blowing cooling air (4,40) in the grate cooler (3),
and wherein the hot air is separated into three fractions, from upstream to downstream, according to the direction of advancement of the materials in the grate cooler, with said three fractions of hot air being at decreasing temperatures, comprising respectively a first air fraction (5) acting as combustion air in at least said combustion zone of the rotary furnace and/or of the potential precalciner of the installation, a second intermediate air fraction (6), and a third air fraction (7), at lower temperature,
wherein:
at least one portion (71) of the air of the third fraction (7) is directed to said at least one combustion zone of the rotary furnace and/or of the precalcinator to be used as combustion air with said first air fraction (5), and said second air fraction (6), greater than the combustion air needs, is valorised for the production of energy.

2. Method according to claim 1, wherein the flow rate of said portion (71) of the air of said third fraction (7) used as combustion air is adjusted by the action of one or several adjusting members (91, 92) in order to maintain the temperature of the air of said second air fraction (6) at a predetermined value, by increasing the flow rate of said portion (71) of the air of the third fraction used as combustion air in order to increase the temperature of the second fraction (6) and by decreasing the flow rate of the portion (71) of the air of the third fraction used as combustion air in order to provoke the opposite effect, namely the decrease in the temperature of the second air fraction (6).

3. Method according to claim 2, wherein the predetermined value is chosen between 350° C. and 480° C.

4. Method according to claim 1, wherein said installation comprises said precalcinator associated with the cyclone preheater (1) and wherein the first fraction (5) comprises the secondary air (51) used as combustion air at the rotary furnace (2) and of the tertiary air (51), conveyed separately to said precalcinator.

5. Method according to claim 4, wherein said portion (71) of the air of said third fraction (7) used as combustion air is mixed with the tertiary air (52), without being mixed with the secondary air (51).

6. Method according to claim 1, wherein said second air fraction (6) is directed to an exchanger (8) for the purpose of concerting heat into electrical energy.

7. Method according to claim 6, wherein the air cooled by said exchanger (8) is used as cooling air (40) at said grate cooler (3).

8. Method according to claim 1, wherein only a portion (71) of the air of the third fraction (7) is mixed with the combustion air of the first fraction (5), with another portion (72) being conveyed separately from said portion (71).

9. Method according to claim 8, wherein said other portion (72) of the third fraction (7) is used as cooling air (40) at said grate cooler (3).

10. Method according to claim 6, wherein the fumes (12) coming from the cyclone preheater (1) are directed to an exchanger (81) for the purpose of converting heat into electricity.

11. Method according to claim 10, wherein the exchangers (8) and (81) respectively treat the second air fraction (6) and the fumes (12) of the cyclone preheater cooperate for the production of electricity.

12. Method according to claim 1, wherein said sintered material is cement clinker.

13. Method according to claim 2, wherein said installation comprises said precalcinator associated with the cyclone preheater (1) and wherein the first fraction (5) comprises the secondary air (51) used as combustion air at the rotary furnace (2) and of the tertiary air (51), conveyed separately to said precalcinator.

14. Method according to claim 3, wherein said installation comprises said precalcinator associated with the cyclone preheater (1) and wherein the first fraction (5) comprises the secondary air (51) used as combustion air at the rotary furnace (2) and of the tertiary air (51), conveyed separately to said precalcinator.

15. Method according to claim 2, wherein said second air fraction (6) is directed to an exchanger (8) for the purpose of concerting heat into electrical energy.

16. Method according to claim 3, wherein said second air fraction (6) is directed to an exchanger (8) for the purpose of concerting heat into electrical energy.

17. Method according to claim 4, wherein said second air fraction (6) is directed to an exchanger (8) for the purpose of concerting heat into electrical energy.

18. Method according to claim 5, wherein said second air fraction (6) is directed to an exchanger (8) for the purpose of concerting heat into electrical energy.

19. Method according to claim 2, wherein only a portion (71) of the air of the third fraction (7) is mixed with the combustion air of the first fraction (5), with another portion (72) being conveyed separately from said portion (71).

20. Method according to claim 3, wherein only a portion (71) of the air of the third fraction (7) is mixed with the combustion air of the first fraction (5), with another portion (72) being conveyed separately from said portion (71).
